(19) United States
(12) Patent Application Publication
(10) Pub. No.: US 2025/0335357 A1
(43) Pub. Date: Oct. 30, 2025

(54) FIXED RATIO MEMORY TIERING WITH VARIABLE CACHE LINE SIZE

(71) Applicant: Micron Technology, Inc., Boise (ID)

(72) Inventors: Patrick Estep, Rowlett, TX (US); Brian Hirano, Longmont, CO (US); Stephen S. Pawlowski, Beaverton, OR (US)

(21) Appl. No.: 19/192,991

(22) Filed: Apr. 29, 2025

Related U.S. Application Data
(60) Provisional application No. 63/640,072, filed on Apr. 29, 2024.

(51) Int. Cl. G06F 12/0811

(52) U.S. Cl. CPC G06F 12/0811

(57) ABSTRACT

Apparatus and methods are disclosed, including sending, by an application executing on a processor of a computing system to a dynamic random access memory (DRAM), a memory operation indicating a DRAM cache line stored in the DRAM; receiving, by the processor, DRAM metadata stored in the DRAM for the DRAM cache line; identifying, by the processor, a tiered memory region of multiple tiered memory regions storing a tiered memory cache line containing target data of the memory operation when the DRAM metadata indicates that the target data is not stored in the DRAM cache line; and loading the tiered memory cache line containing the target data into the DRAM, loading the DRAM cache line into the identified tiered memory region, and updating the DRAM metadata.

### PRIORITY APPLICATION

This application claims the benefit of priority to U.S. Provisional Application Ser. No. 63/640,072, filed Apr. 29, 2024, which is incorporated herein by reference in its entirety.

### BACKGROUND

Memory devices are semiconductor circuits that provide electronic storage of data for a host system (e.g., a computer or other electronic device). Memory devices may be volatile or non-volatile. Volatile memory requires power to maintain data, and includes devices such as random-access memory (RAM), static random-access memory (SRAM), dynamic random-access memory (DRAM), or synchronous dynamic random-access memory (SDRAM), among others. Non-volatile memory can retain stored data when not powered, and includes devices such as flash memory, read-only memory (ROM), electrically erasable programmable ROM (EEPROM), erasable programmable ROM (EPROM), resistance variable memory, such as phase change random access memory (PCRAM), resistive random-access memory (RRAM), or magnetoresistive random access memory (MRAM), among others.

Host systems typically include a host processor, a first amount of main memory (e.g., often volatile memory, such as DRAM) to support the host processor, and one or more memory systems (e.g., often non-volatile memory, such as flash memory, and may include volatile memory) that provide additional storage to retain data in addition to or separate from the main memory.

A memory system, can include a memory controller and one or more memory devices, including a number of dies or logical units (LUNs). In certain examples, each die can include a number of memory arrays and peripheral circuitry thereon, such as die logic or a die processor. The memory controller can include interface circuitry configured to communicate with a host device (e.g., the host processor or interface circuitry) through a communication interface (e.g., a bidirectional parallel or serial communication interface). The memory controller can receive commands or operations from the host system in association with memory operations or instructions, such as read or write operations to transfer data (e.g., user data and associated integrity data, such as error data or address data, etc.) between the memory devices and the host device, erase operations to erase data from the memory devices, perform drive management operations (e.g., data migration, garbage collection, block retirement), etc.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example computing system including a host device and a memory system.

FIG. 2 is a block diagram of portions of an example of a memory system.

FIG. 3 is a block diagram of portions of another example of a memory system.

FIG. 4 is a flow diagram of an example of a method of operating a computer system.

FIGS. 5-8A are diagrams illustrating portions of dynamic random access memory (DRAM) and tiered memory of a memory system.

FIG. 8B is a table showing an example of memory accesses using the memory example of FIG. 8A.

FIG. 9A and FIG. 9B show examples of different operation sequences for accessing tiered memory regions of a memory system.

FIG. 10 illustrates an example block diagram of a host system.

### DETAILED DESCRIPTION

Software (e.g., programs), instructions, operating systems (OS), and other data are typically stored on storage systems and accessed for use by a host processor. Main memory (e.g., RAM) is typically faster, more expensive, and a different type of memory device (e.g., volatile) than a majority of the memory devices of the storage system (e.g., non-volatile, such as an SSD, etc.). In addition to the main memory, host systems can include different levels of volatile memory, such as a group of static memory (e.g., a cache, often SRAM), often faster than the main memory, in certain examples, configured to operate at speeds close to or exceeding the speed of the host processor, but with lower density and higher cost. Systems can include high speed, low latency compute express link (CXL) compatible memory. The CXL compatible memory provides a high capacity link between processors and the memory system. In other examples, more or less levels or quantities of main memory or static memory can be used, depending on desired host system performance and cost.

When the static memory is full, various replacement policies can be implemented to free static memory to improve system performance, often writing a portion of the static memory to the main memory or erasing that portion of the static memory depending on one or more factors, including least recently used (LRU) data, most recently used (MRU) data, first in first out (FIFO) data, last in first out (LIFO) data, least frequently used (LFU) data, random replacement (RR) data, etc. When the main memory is full, virtual space from the memory system can be allocated to supplement the main memory.

The memory system can also include different levels of memory cells. The different levels of memory cells can be of different memory types that involve different latencies in accessing types of memory cells. Additionally, the memory system can include memory that is disaggregated and access to the disaggregated memory involves different communication links. The present inventors have recognized, among other things, that memory-tiering the RAM of host devices in multiple tiered memory devices can extend the memory available to host devices and still maintain near-RAM performance.

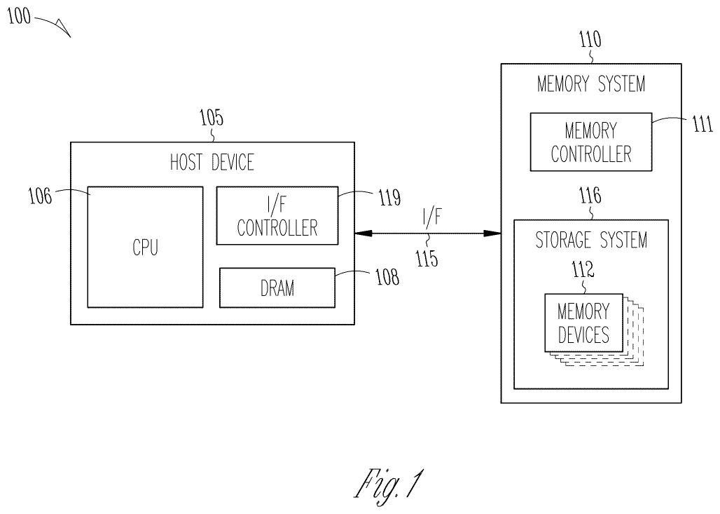

FIG. 1 illustrates an example computing system (e.g., a host system) 100 including a host device 105 and a memory system 110 that includes a CXL-compatible storage system 116 configured to communicate over a communication interface (I/F) 115 (e.g., a bidirectional parallel or serial communication interface). The host device 105 can include a host processor 106 (e.g., a host central processing unit (CPU) or other processor or processing device) or other host circuitry (e.g., a memory management unit (MMU), interface circuitry, assessment circuitry, etc.). In certain examples, the host device 105 can include a main memory that includes DRAM 108 to support operation of the host processor 106. The storage system 116 can include multiple memory devices 112. The storage system 116 includes a high-capacity link between the memory controller 111 and the Storage system 116. To access the storage system 116, the host device 105 may send instructions to a communication interface controller (119) that routes a memory request to the memory controller 111.

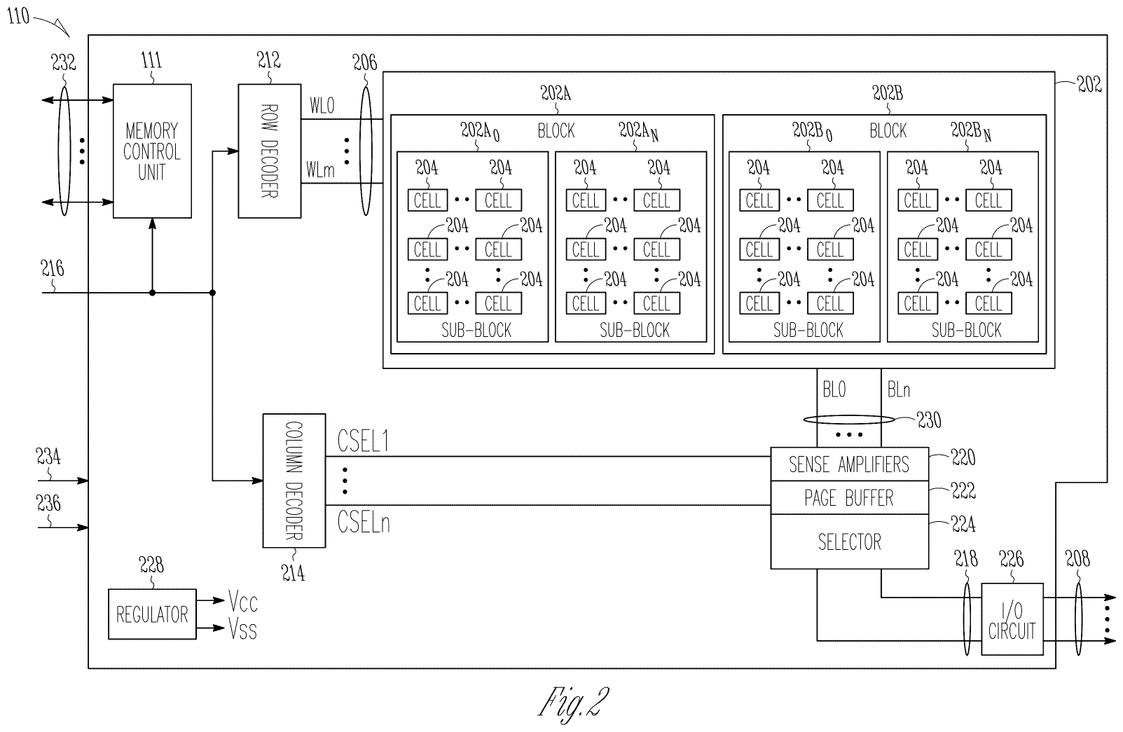

FIG. 2 illustrates an example block diagram of portions of a memory system 110 including a memory array 202 having a plurality of memory cells 204, and one or more circuits or components to provide communication with, or perform one or more memory operations on, the memory array 202. The memory array 202 can be included in the storage system 116 of FIG. 1. Although shown with a single memory array 202, in other examples, one or more additional memory arrays, dies, or LUNs can be included herein. The memory system 110 can include a row decoder 212, a column decoder 214, sense amplifiers 220, a page buffer 222, a selector 224, an input/output (I/O) circuit 226, and a memory controller 111.

The memory cells 204 of the memory array 202 can be arranged in blocks, such as first and second blocks 202A, 202B. Each block can include sub-blocks. For example, the first block 202A can include first and second sub-blocks 202A₀, 202Aₙ, and the second block 202B can include first and second sub-blocks 202B₀, 202Bₙ. Each sub-block can include a number of physical pages, each page including a number of memory cells 204. Although illustrated herein as having two blocks, each block having two sub-blocks, and each sub-block having a number of memory cells 204, in other examples, the memory array 202 can include more or fewer blocks, sub-blocks, memory cells, etc. In other examples, the memory cells 204 can be arranged in a number of rows, columns, pages, sub-blocks, blocks, etc., and accessed using, for example, access lines 206, first data lines 230, or one or more select gates, source lines, etc.

The memory controller 111 can control memory operations of the memory system 110 according to one or more signals or instructions received on control lines 232, including, for example, one or more clock signals or control signals that indicate a desired operation (e.g., write, read, erase, etc.), or address signals (A0-AX) received on one or more address lines 216. One or more devices external to the memory system 110 can control the values of the control signals on the control lines 232, or the address signals on the address line 216. Examples of devices external to the memory system 110 can include, but are not limited to, a host, a memory controller, a processor, or one or more circuits or components not illustrated in FIG. 2.

The memory system 110 can use access lines 206 and first data lines 230 to transfer data to (e.g., write or erase) or from (e.g., read) one or more of the memory cells 204. The row decoder 212 and the column decoder 214 can receive and decode the address signals (A0-AX) from the address line 216, can determine which of the memory cells 204 are to be accessed, and can provide signals to one or more of the access lines 206 (e.g., one or more of a plurality of word lines (WL0-WLm)) or the first data lines 230 (e.g., one or more of a plurality of bit lines (BL0-BLn)), such as described above.

The memory system 110 can include sense circuitry, such as the sense amplifiers 220, configured to determine the values of data on (e.g., read), or to determine the values of data to be written to, the memory cells 204 using the first data lines 230. For example, in a selected string of memory cells 204, one or more of the sense amplifiers 220 can read a logic level in the selected memory cell 204 in response to a read current flowing in the memory array 202 through the selected string to the data lines 230.

One or more devices external to the memory system 110 can communicate with the memory system 110 using the I/O lines (DQ0-DQN) 208, address lines 216 (A0-AX), or control lines 232. The input/output (I/O) circuit 226 can transfer values of data in or out of the memory system 110, such as in or out of the page buffer 222 or the memory array 202, using the I/O lines 208, according to, for example, the control lines 232 and address lines 216. The page buffer 222 can store data received from the one or more devices external to the memory system 110 before the data is programmed into relevant portions of the memory array 202, or can store data read from the memory array 202 before the data is transmitted to the one or more devices external to the memory system 110.

The column decoder 214 can receive and decode address signals (A0-AX) into one or more column select signals (CSEL1-CSELn). The selector 224 (e.g., a select circuit) can receive the column select signals (CSEL1-CSELn) and select data in the page buffer 222 representing values of data to be read from or to be programmed into memory cells 204. Selected data can be transferred between the page buffer 222 and the I/O circuit 226 using second data lines 218.

The memory controller 111 can receive positive and negative supply signals, such as a supply voltage (Vcc) 234 and a negative supply (Vss) 236 (e.g., a ground potential), from an external source or supply (e.g., an internal or external battery, an AC-to-DC converter, etc.). In certain examples, the memory controller 111 can include a regulator 228 to internally provide positive or negative supply signals.

Returning to the example system 100 of FIG. 1, to access the

memory devices 112 the host device 105 may send instructions to an I/F controller 119. The I/F controller 119 will route tiered memory requests to the memory controller 111. The memory controller 111 can include, among other things, circuitry or firmware, such as a number of components or integrated circuits. For example, the memory controller 111 can include one or more memory controllers, circuits, or components configured to control access across the memory array and to provide a translation layer between the host device 105 and the memory system 110.

The memory devices 112 can include a non-volatile memory array (e.g., a 3D NAND architecture semiconductor memory array) that can include a number of memory cells arranged in, for example, a number of devices, planes, blocks, or physical pages. As one example, a TLC memory device can include 18,592 bytes (B) of data per page, 1536 pages per block, 548 blocks per plane, and 4 planes per device. As another example, an MLC memory device can include 18,592 bytes (B) of data per page, 1024 pages per block, 548 blocks per plane, and 4 planes per device, but with half the required write time and twice the program/erase (P/E) cycles as a corresponding TLC memory device. Other examples can include other numbers or arrangements.

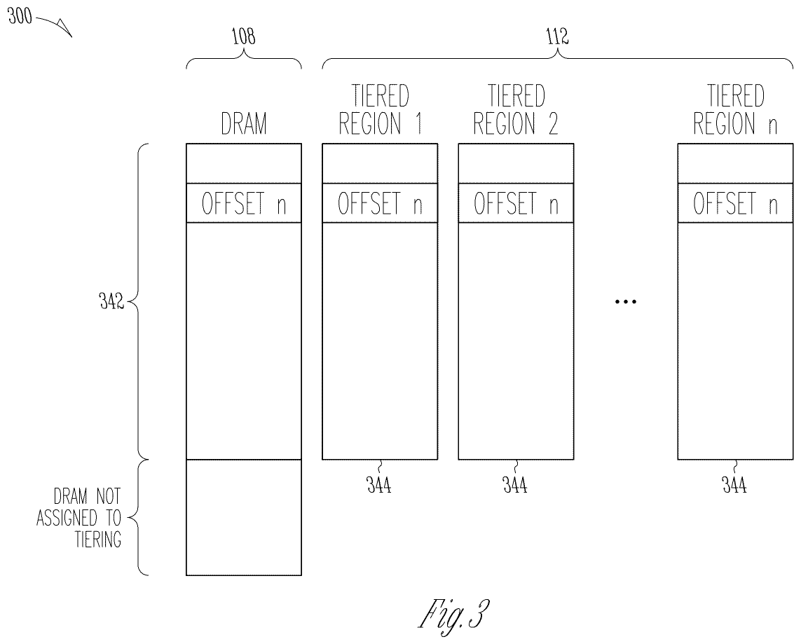

FIG. 3 is a block diagram of an example of memory of a computing system such as the system 100 of FIG. 1. The memory 300 includes DRAM 108 and tiered memory devices 112. The tiered memory includes n tiered regions 344, where n is a positive integer greater than 1 (e.g., n may be an integer in the range of 2-16). More than one tiered region 344 may reside on one tiered memory device 112. The DRAM 108 includes a memory tiering portion having a fixed memory tiering block size (128 Gigabytes or 128 GB in the example). Each of the n tiered regions are of the same size as the memory tiering block size 342 of the DRAM 108. The DRAM 108 may include additional memory not assigned to tiering. The virtual address space of the memory is divided over the n+1 memory regions of memory 300 including the DRAM 108 and the n tiered regions 344. For instance, if n=3 and the memory tiering block size is 128 GB, the virtual address range is 512 GB with one fourth of the address range storable in each of the DRAM and each of the 3 tiered memory regions.

In general, the host processor 106 performs memory operations to cache lines stored in DRAM 108. Physical access to the DRAM 108 and the memory device or memory devices 112 is done using an Offset computed using the block size and the virtual address space. For instance, if the block size is 128 GB and there are 3 tiered regions, there are n+1=4 memory blocks of 128 GB and the virtual address space is 512 GB. The physical address of a memory operation is the Offset

Offset=(virtual address) % 128 GB,

where “%” refers to the modulo operation. The target data of the memory operation is stored (e.g., in a cache line) in the DRAM or one of the tiered memory regions at the Offset address.

Applications running on the host processor 106 request read and write memory operations that are generally to and from the DRAM 108, and as the applications generate data, the data flows into the n+1 memory regions starting with the DRAM 108. Eventually data becomes scattered throughout the n+1 memory regions. It is transparent to the applications running on the host processor 106 if the target data of the address is in DRAM 108 or one of the tiered regions 344. The host processor 106 may use metadata to identify what data is in the computing system 100 and where it is located.

If the target data is in a DRAM cache line of the DRAM 108 (i.e., a DRAM hit), the memory operation concludes with the DRAM access. If the target data is not in the DRAM 108 (i.e., a DRAM miss), the target data is in a tiered memory cache line of one of the tiered memory regions. The tiered memory cache line containing the target data is located and a swap of the tiered memory cache line and the corresponding DRAM cache line is performed. The corresponding DRAM cache line may be the cache line in DRAM 108 having the same Offset as the tiered memory cache line. In variations, a cache line stores more than one Offset address, and the corresponding DRAM cache line may be the cache line in DRAM 108 that includes the same Offset address as the tiered memory cache line. In the case of a DRAM miss, the memory operation concludes with 3 memory accesses (1DRAM access and 2 tiered memory accesses). Memory operations where the target data is in a DRAM cache line have lower latency than memory operations where the target data is in a tiered memory cache line. Because memory operations tend to access the same data repeatedly, the memory operations are more often to DRAM 108 than the tiered memory regions 344.

Using tiered memory regions in a ratio to the DRAM tiering block size increases the size of the memory footprint while still providing near-DRAM performance and allows the memory system to be implemented with less expensive tiered CXL-compatible memory. The tiered memory is cheaper and has more capacity. A challenge of the technique is in tracking the location of target data in the event of a DRAM miss.

As explained previously herein, in the event of a DRAM miss, the host processor 106 identifies the tiered memory cache line of a tiered memory region of the Storage system 116 that contains target data of the memory operation and swaps the identified tiered memory cache line and the corresponding DRAM cache line. After multiple DRAM misses, the cache lines for a portion of the virtual address space may have been moved to any tiered memory region. Different methods can be used to identify the tiered memory region and cache line storing the target data. Metadata can be stored with data and the metadata may be used to identify the target data or where the target data resides. Different approaches to using metadata to track data can involve tradeoffs. Methods that are fast to locate the tiered memory cache line storing the target data can involve more overhead data. Methods that use less overhead data can be slower to locate the tiered memory cache line storing the target data, which may increase the latency of the response to the memory operation.

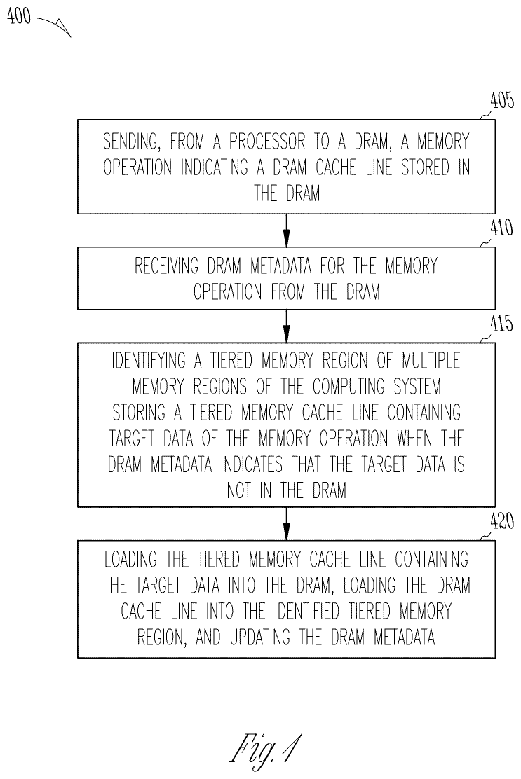

FIG. 4 is a flow diagram of an example of method 400 of operating a computer system (e.g., the computer system 100 in FIG. 1). At block 405, a memory operation is sent by an application executing on a processor of the computing system to DRAM 108 of the computing system. The memory operation may originate with a virtual address of the target data, and the memory operation sent to the DRAM 108 indicates a cache line address in the DRAM 108. The cache line address may be determined as an Offset into the DRAM 108. For example, as explained previously herein, the virtual address space may be divided over the DRAM and the tiered memory regions 112 of a storage system. If there are four total memory regions (as in the example of FIG. 3) the DRAM 108 may store one-fourth of the virtual address space and the cache line address in the memory operation is an Offset or index into the one-fourth of the virtual address space.

At block 410, metadata for the memory operation is received and decoded by the processor. The metadata may be DRAM metadata stored in the DRAM 108 and returned by the DRAM or read from the DRAM as part of the memory operation. The DRAM metadata includes information about the data in the DRAM cache line, and the processor can determine from the metadata if the data in the DRAM cache line is the intended target data. For example, the metadata may indicate to which portion of the virtual address space data the DRAM cache line belongs. The processor can determine if the DRAM cache line is for the correct portion of the virtual address space and contains the target data. If the DRAM metadata indicates that the target data is currently in DRAM 108 (i.e., a DRAM hit), the memory operation concludes with the DRAM access and the memory operation is completed. If the metadata indicates that the target data is not in DRAM 108 (i.e., a DRAM miss), the target data is in the tiered memory 112.

At block 415, the processor identifies the tiered memory region 112 of the memory system 100 storing a tiered memory cache line containing the target data of the memory operation when the DRAM metadata indicates that the target data is not stored in the DRAM cache line (i.e., a DRAM miss). At block 420, when the correct tiered memory cache line is identified, the processor swaps the tiered memory cache line and the DRAM cache line. The tiered memory cache line containing the target data is loaded into the DRAM 108, and the DRAM cache line is loaded into the identified tiered memory region. The DRAM metadata is updated to reflect the cache line swap.

Different approaches can be used to locate the correct tiered memory cache line in the multiple tiered memory regions. As explained previously herein, each of the n+1 memory regions stores cache lines that may be indexed using an Offset determined from the virtual address space. Each of the tiered memory regions 112 stores a tiered memory cache line corresponding to the DRAM cache line. In one approach, the DRAM metadata for a DRAM cache line includes enough metadata bits to identify the location and contents of each of the corresponding tiered memory cache lines.

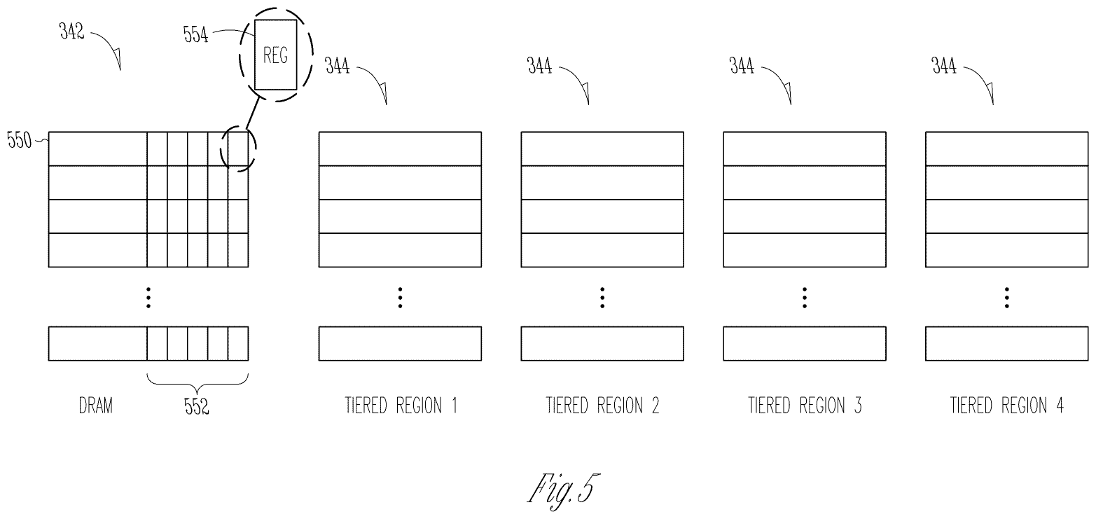

FIG. 5 is a diagram representing a portion of the DRAM 342 and the tiered memory regions 344 of FIG. 3 when n=4. The diagram shows cache lines 550 in the memory regions. The cache lines 550 shown in the same row of the memory regions represent those cache lines in the memory regions that are indexed using the same Offset into the memory region (as in the example of FIG. 3). The diagram shows that only the DRAM 342 includes metadata (DRAM metadata 552).

In the example of FIG. 5, there are five memory regions (a DRAM and four tiered memory regions of the same size as the DRAM size, or n+1=5 for the 4-to-1 ratio) and the DRAM metadata 552 holds five groups of metadata bits. One group of metadata bits stores information for the DRAM cache line and each of the other four groups of metadata bits stores information for a tiered memory cache line of one of the tiered memory regions. Each group of metadata represents information of which portion (or region 554) of the virtual address space the cache line belongs to. Therefore, the processor can look at (e.g., read or decode) the DRAM metadata and immediately identify whether the target data is in the DRAM cache line, and if it is not, quickly identify where the tiered memory cache line that is holding the target data is located.

In the example of FIG. 5, because there are five memory regions, the virtual address space is divided into five regions or portions, each including 20% of the virtual address space. Each group of the DRAM metadata 552 includes 3 bits to identify which of the five address portions the data in the DRAM cache line or tiered memory cache line belongs to. Because there are five groups of metadata bits, 15 bits of metadata are used for each DRAM cache line in the DRAM to track the location of data. A smaller memory footprint will use less metadata bits and a larger footprint will use more metadata bits. For instance, for a smaller tiered memory including two tiered memory regions, there are three total memory regions (n+1=3) and the virtual address space is divided into three portions each including one-third of the virtual address space. There are three groups of metadata bits (one for the DRAM and two for the tiered memory regions) and each group of metadata bits includes 2 bits to identify which of the three address portions the data in the DRAM cache line or tiered memory cache line belongs to, for a total of 6 bits of metadata for each DRAM cache line. For larger tiered memories, the number of metadata bits stored in the DRAM can become large (e.g., a 15-to-1 ratio would need 16 groups of metadata bits with each group including 4 bits for a total of 64 metadata bits for each cache line).

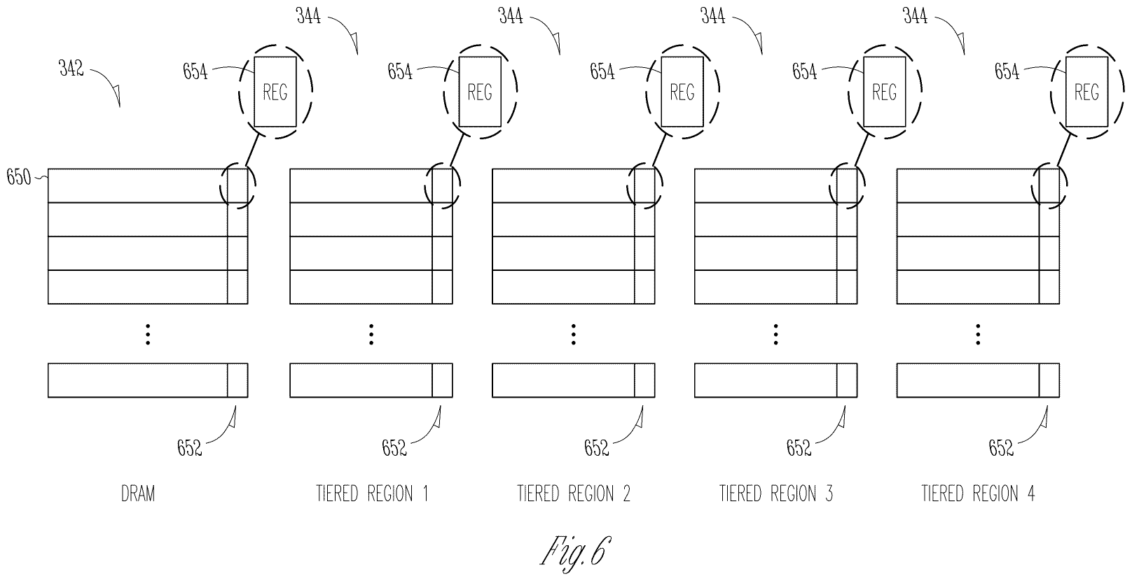

FIG. 6 shows another approach to locating a cache line that stores the target data for a memory operation. FIG. 6 is a diagram representing a portion of the DRAM 342 and the tiered memory regions 344 of FIG. 3 when n=4. The diagram shows cache lines 650 in the memory regions. The diagram shows that both the DRAM 342 and the tiered memory regions 344 include metadata 652 (DRAM metadata and tiered memory metadata). The DRAM metadata and the tiered memory metadata each include one group of metadata bits to identify which portion (or region 654) of the virtual address space the DRAM cache line or the tiered memory cache line belongs to. Because the memory is the same size as in FIG. 5, the virtual address space again includes 5 regions and each group of metadata bits 652 includes 3 bits to identify one of the four portions of the virtual address space.

For a memory operation using the approach in FIG. 6, the processor reads the DRAM metadata bits for the DRAM cache line to see if the target data is in the DRAM cache line. If the target data is in the DRAM cache line the memory operation concludes with the DRAM access. If the target data is not in the DRAM cache line, the processor searches the tiered memory metadata of the tiered memory regions (e.g., using random searching) to locate the tiered memory cache line that includes the target data. When the tiered memory cache line is found, the processor swaps the data of the DRAM cache line and the tiered memory cache line and swaps the DRAM metadata and tiered memory metadata to identify the appropriate portions of the virtual address space. Because there is only one group of DRAM metadata bits, the approach of FIG. 6 uses less DRAM for storing metadata. However, because the location is unknown in the event of a DRAM miss there may have to be four searches performed to find the correct tiered memory cache line in a worst-case scenario.

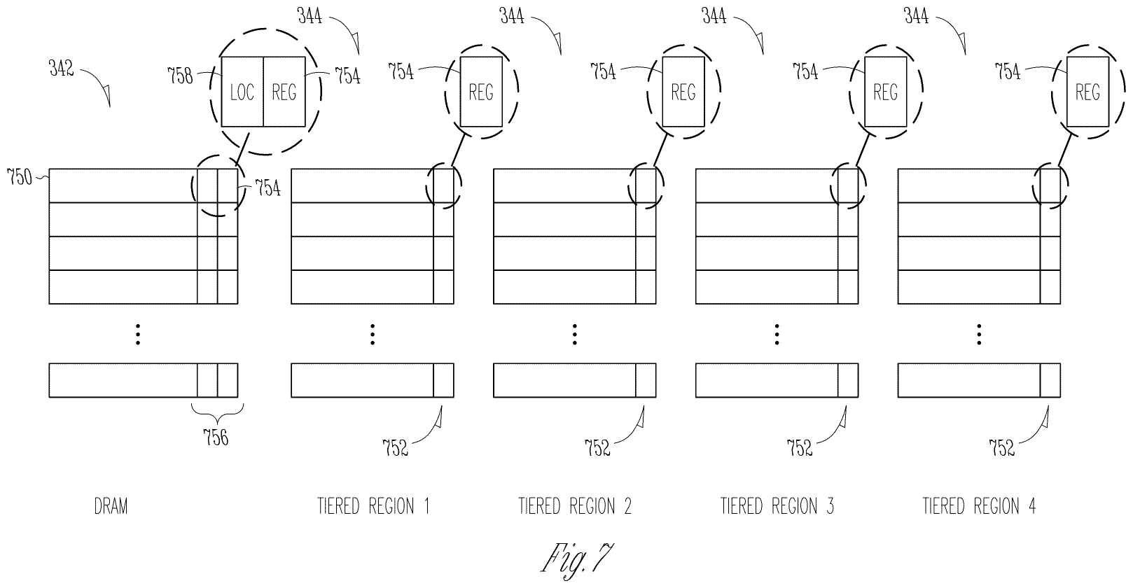

FIG. 7 shows still another approach to locating a cache line that stores the target data for a memory operation. Like FIGS. 5 and 6, FIG. 7 is a diagram representing a portion of the DRAM 342 and the tiered memory regions 344 of FIG. 3 when n=4. The diagram in FIG. 7 shows cache lines 750 in the memory regions. The diagram shows that the DRAM 342 includes DRAM metadata 756 and the tiered memory regions 344 include tiered memory metadata 752. The tiered memory metadata 752 is the same as in FIG. 6 and includes bits to identify which portion (or region 754) of the virtual address space the tiered memory cache line belongs to.

The DRAM metadata 756 includes at least two groups of metadata bits per cache line and less groups of metadata bits than the number of memory regions (e.g., less than 5 groups of metadata bits in the example of FIG. 7). One group of metadata bits identifies which portion or region 754 of the virtual address space the DRAM cache line belongs to. The second group includes metadata bits that identify a region 754 of the virtual address space to which a tiered memory cache line belongs and metadata bits that identify the location 758 (e.g., the tiered memory region) of the tiered memory cache line. Thus, the second group of metadata bits identifies where to find a tiered memory cache line if the target data belongs to the same portion of the virtual address space of the tiered memory cache line.

For a memory operation using the approach of FIG. 7, the processor reads the DRAM metadata bits for the DRAM cache line to see if the target data is in the DRAM cache line. If the target data is in the DRAM cache line the memory operation concludes with the DRAM access. If the target data is in the tiered memory cache line identified in the DRAM metadata 756, no searching is needed and the processor swaps the data of the tiered memory cache line and the DRAM cache line and updates the DRAM metadata 756 and tiered memory metadata 752 to reflect the change. If the target data does not belong to the DRAM cache line or the identified tiered memory cache line, the processor searches the tiered memory metadata of the other tiered memory regions (i.e., those tiered memory regions not identified in the DRAM metadata 756) to locate the tiered memory cache line that includes the target data. When the tiered memory cache line is found, the processor swaps the data of the DRAM cache line and the tiered memory cache line and updates the DRAM metadata and tiered memory metadata to reflect the change. It should be noted that the amount of searching needed to locate the correct tiered memory cache line in the example of FIG. 7 can be less than the amount of searching needed in the example of FIG. 6. Because one tiered memory region 344 is identified in the DRAM metadata 756, the processor does not search that tiered memory region for the cache line. Thus, the worst-case scenario is three searches to find the correct tiered memory cache line in contrast to four searches in the worst-case scenario in the approach of FIG. 6.

The DRAM metadata 756 may include more groups of metadata bits to identify the contents and location of more than one tiered memory cache line, but only for a subset of the tiered memory regions (e.g., tiered memory cache lines for 2-4 tiered memory regions 344). Identifying less tiered memory cache lines uses less DRAM for storing metadata. If the DRAM metadata 756 stores the content and location for more than one tiered memory cache line, the processor may use a replacement algorithm to update the tiered memory cache line information in the DRAM metadata 756. For instance, the processor may replace the tiered memory cache line information using a least recently used (LRU) algorithm.

Memory performance can be improved by accessing memory using a larger cache line. Memory operations also tend to access memory addresses that are close together. For example, if the cache line size for an application for the host processor 106 is sixty-four bytes (64 B), the interface to the DRAM 108 can operate on a cache line that is twice as large (128 B) or four times as large (256 B). Because memory operations often access data that is stored in addresses close together, increasing the size of the cache line can improve the percentage of memory accesses that are resolved in DRAM to improve memory performance. For the technique in the example of FIG. 6, increasing the size of the cache line can reduce the number of random searches that need to be performed.

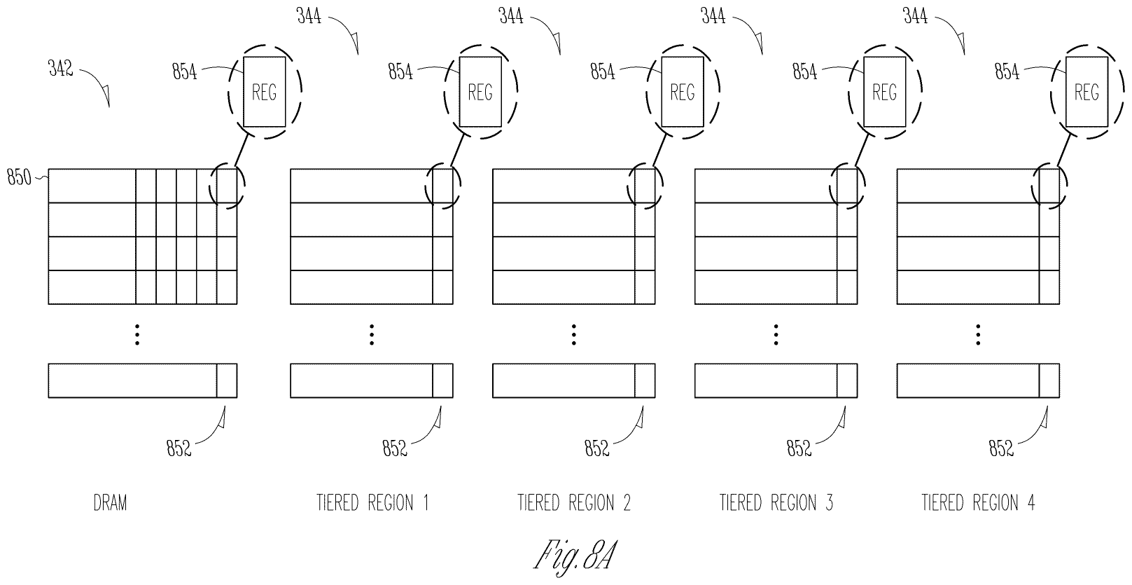

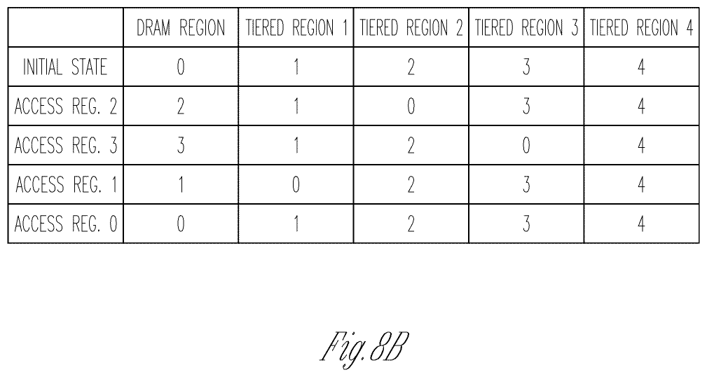

FIG. 8A shows another approach to locating a cache line that stores the target data for a memory operation. FIG. 8A is a diagram representing a portion of the DRAM 342 and the tiered memory regions 344 of FIG. 3 when n=4. The diagram shows cache lines 850 in the memory regions. The diagram shows that both the DRAM 342 and the tiered memory regions 344 include respective metadata 852 (DRAM metadata and tiered memory metadata). The DRAM metadata and the tiered memory metadata each include one respective group of metadata bits to identify which portion (or region 854) of the virtual address space the DRAM cache line or the tiered memory cache line belongs to. Because the memory is the same size as in FIG. 5, the virtual address space includes five regions and each group of metadata bits 852 includes, for example, three bits to identify one of the four portions of the virtual address space.

For a memory operation using the approach in FIG. 8A, the processor reads the DRAM metadata bits for the DRAM cache line to see if the target data is in the DRAM cache line. If the target data is in the DRAM cache line the memory operation concludes with the DRAM access. If the target data is not in the DRAM cache line, the processor swaps the cache line in DRAM 342 with the content of the cache line of the tiered memory region owning the DRAM cache line. The processor then swaps the current DRAM cache line with the target tiered memory region cache line. The result is the target data is in the DRAM cache line.

FIG. 8B is a table showing an example of accesses to the tiered memory regions. The first row of the table shows the initial state with the memory regions showing the owning tiered memory regions of the cache lines in FIG. 8A with the DRAM region being region zero. The second row of the table shows the result of an access where the target was in the tiered memory Region 2 and not in the DRAM. The cache line of the DRAM is swapped with the cache line of the target in tiered memory Region 2. The DRAM metadata identifies the contents as belonging to tiered memory Region 2, and the tiered memory metadata in tiered memory Region 2 identifies the contents as belonging to the DRAM Region (Region 0).

In the third row of the table, the target of the access was tiered memory Region 3. At the time of the access, the cache line currently in DRAM was owned by tiered memory Region 2. The cache line in the DRAM is written back to the owner tiered memory Region 2 identified in the DRAM metadata. The cache line previously in tiered memory Region 2 is swapped with the target cache line of tiered memory Region 3. As shown in the table, after the access, the DRAM metadata identifies the contents as belonging to tiered memory Region 3, and the tiered memory metadata in the cache line of tiered memory Region 3 identifies the contents as belonging to DRAM Region 0. The fourth and fifth rows of the table show the results of access to tiered memory Region 1 and DRAM Region 0, respectively. In the example of FIGS. 8A and 8B, the processor does not have to search for the contents of the tiered memory metadata of the tiered memory regions to locate the tiered memory cache line that includes the target data. The cost of the approach of FIGS. 8A and 8B is that an extra read and write may need to be performed to swap the cache line back to the owning tiered memory region before swapping the target cache line with the DRAM cache line.

There are different ways of swapping the cache lines of DRAM and the tiered memory regions. In the example of FIG. 8B, to transition from the state of row 2 to the state of row 3, the cache line currently stored in tiered memory Region 2 needs to be saved prior to the writeback from the DRAM region back to tiered memory Region 2. The tiered memory Region 3 contents are written to the DRAM region and the saved DRAM cache line is written back to tiered memory Region 3. It should be noted that this remains true in other movements between DRAM and tiered memory regions. If the tiered memory region contains a DRAM line and data from a different tiered memory Region has been requested to the DRAM cache, the move of the DRAM cache line from the initial tiered memory region to the newly requested tiered memory region always occurs.

In another approach to moving cache lines between DRAM and tiered memory regions, two or more of the respective memory devices hosting the tiered memory regions can be configured to communicate directly with each other. In this case, for a transition from the state of row 2 to the state of row 3 in the example in FIG. 8B, the DRAM cache line (region 0 cache line) can be moved directly from tiered memory region 2 to tiered memory region 3, without having to move data back to the host (e.g., where the DDR DRAM cache resides). In an example, coordinating data movement between the tiered memory regions and data communication with the host can use specialized memory access protocols.

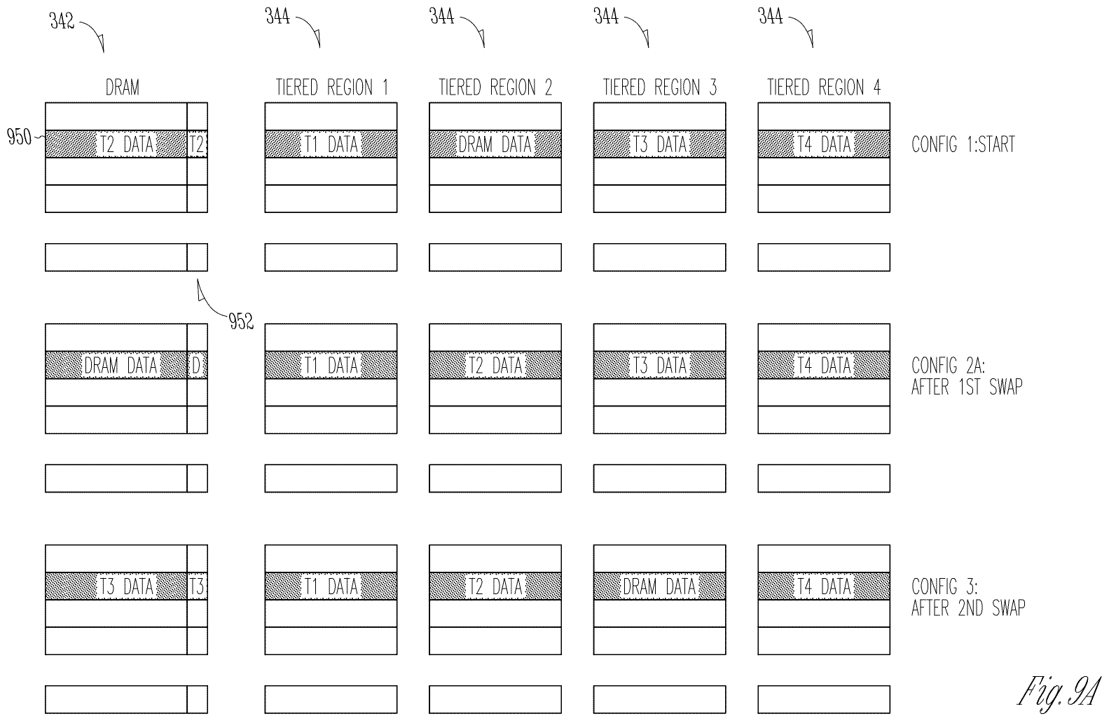

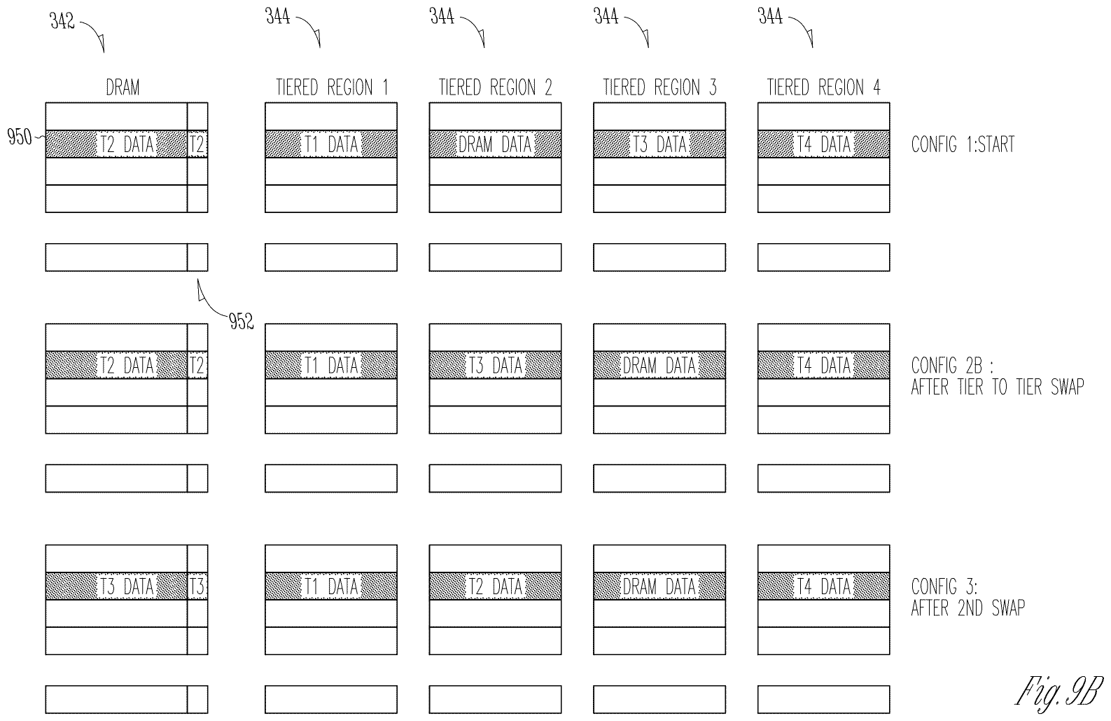

FIG. 9A and FIG. 9B show other approaches to locating a cache line that stores the target data for a memory operation. Each of FIGS. 9A and 9B represent a portion of the DRAM 342 and the tiered memory regions 344 of FIG. 3 when n=4. The diagrams show cache lines 950 in the memory regions. The diagrams show that the DRAM 342 includes metadata 952 (DRAM metadata). In the examples of FIG. 9A and FIG. 9B, the tiered memory regions do not include cache line metadata that identifies an owning memory region. However, other types of tiered memory region metadata can optionally be used. The DRAM metadata includes respective groups of metadata bits to identify which portion or region of the virtual address space the DRAM cache line belongs to. Because the memory is the same size as in FIG. 5, the virtual address space includes five regions and each group of metadata bits 952 includes, for example, three bits to identify one of the four portions of the virtual address space. At any time, either the DRAM data is in its original or owned location in the DRAM 342, or data from a particular tiered region is in the DRAM 342 and the DRAM data is in the particular tiered region. The metadata bits 952 in the DRAM indicate which region the data in the DRAM cache is from.

For a memory operation using the approach in FIG. 9A or FIG. 9B, the processor reads the DRAM metadata bits 952 for the DRAM cache line to see if the target data is in the DRAM cache line. If the target data is in the DRAM cache line then the memory operation concludes with the DRAM access. If the target data is not in the DRAM cache line, then the processor performs a sequence of accesses to swap one or more cache lines in the system and place the target data in the DRAM cache line. FIG. 9A shows a first sequence that includes multiple DRAM accesses, and FIG. 9B shows a second sequence that includes a single DRAM access.

If the target data is not in the DRAM cache line, then the processor swaps the cache line in DRAM 342 with the content of the cache line of the tiered memory region owning the DRAM cache line. The processor then swaps the current DRAM cache line with the target tiered memory region cache line. The result is the target data is in the DRAM cache line.

FIG. 9A illustrates the first sequence of accesses to the tiered memory regions and corresponding configurations of the DRAM and tiered memory regions. In the first sequence, target data includes data from tiered Region 3. That is, the first sequence can be performed to move the target data from its original location at tiered Region 3 to the corresponding cache line 950 in the DRAM 342. The first sequence can include or use two cache line swaps. Beginning at the top of FIG. 9A, CONFIG 1 shows an initial state where the DRAM cache line includes data owned by tiered Region 2 (“T2 DATA”), tiered Region 1 includes its owned data (“T1 DATA”), tiered Region 2 includes data originally owned by the DRAM (“DRAM DATA”), tiered Region 3 includes its owned data (“T3 DATA”) and tiered Region 4 includes its owned data (“T4 DATA”). In CONFIG 1, the metadata bits 952 associated with the DRAM cache line indicate that the data in the cache line 950 of the DRAM is owned by tiered Region 2 (“T2”).

Following CONFIG 1, the example of FIG. 9A proceeds to CONFIG 2A. At CONFIG 2A, the cache line 950 of the DRAM is swapped with the cache line of tiered Region 2 to return the DRAM data to the DRAM 342 and to return T2 DATA to tiered Region 2. In CONFIG 2A, the DRAM metadata identifies the contents as belonging to the DRAM.

Following CONFIG 2A, the example of FIG. 9A proceeds to CONFIG 3. At CONFIG 3, the cache line 950 of the DRAM is swapped with the cache line of tiered Region 3 to place the target data in the DRAM cache, and to place the data owned by the DRAM in tiered Region 3. In CONFIG 3, the DRAM metadata identifies the contents as belonging to tiered Region 3 (“T3”). In the example of FIG. 9A, the respective cache lines in the other tiered Regions 1 and 4 are unused.

In another approach to moving cache lines between DRAM and tiered memory regions, two or more of the respective memory devices hosting the tiered memory regions can be configured to communicate directly with each other. In an example, for a transition between states or configurations of the different memory tiers, a cache line can be moved directly between tiered memory regions without having to move data back to the host (e.g., where the DDR DRAM cache resides). In an example, coordinating data movement between the tiered memory regions and data communication with the host can use specialized memory access protocols.

FIG. 9B illustrates the second sequence of accesses to the tiered memory regions and corresponding configurations of the DRAM and tiered memory regions. In the second sequence, target data includes data from tiered Region 3. That is, the second sequence can be performed to move the target data from its original location at tiered Region 3 to the corresponding cache line 950 in the DRAM 342. Beginning at the top of FIG. 9B, CONFIG 1 shows the same initial state as in the example of the first sequence from FIG. 9A. That is, the DRAM cache line includes the T2 DATA, tiered Region 1 includes the T1 DATA, tiered Region 2 includes the DRAM DATA, tiered Region 3 includes the T3 DATA, and tiered Region 4 includes the T4 DATA. In CONFIG 1, the metadata bits 952 associated with the DRAM cache line indicate that the data in the cache line 950 of the DRAM is owned by tiered Region 2 (“T2”).

CONFIG 2B follows CONFIG 1 in the example of FIG. 9B. At CONFIG 2B, the cache line of tiered Region 2 is swapped with the cache line of tiered Region 3. That is, the DRAM data that was stored in tiered Region 2 at CONFIG 1 is swapped with T3 DATA that was stored in tiered Region 3 at CONFIG 1. In CONFIG 2B, the DRAM maintains the T2 DATA during the cache line swap between tiered Region 2 and tiered Region 3.

Following CONFIG 2B, the example of FIG. 9B proceeds to CONFIG 3. At CONFIG 3, the cache line 950 of the DRAM is swapped with the cache line of tiered Region 2 to place the target data, T3 DATA, in the DRAM cache, and to place the data originally owned by the DRAM in tiered Region 3. In CONFIG 3, the DRAM metadata identifies the contents as belonging to tiered Region 3. In the example of FIG. 9B, the respective cache lines in the other tiered Regions 1 and 4 are unused.

The techniques described in relation to FIGS. 5-9B include varying amounts of metadata overhead and response latency. When implementing a Storage system, different aspects of the system can be adjusted to provide the best solution for the system designer. For example, the number of tiered memory regions can be a small number (e.g., 2 tiered memory regions), a large number (e.g., 16 tiered memory regions) or a size in between. The number of metadata bits to use and where to allocate them (e.g., DRAM of the tiered memory regions) can also be adjusted. Also, the size of the cache line can be adjusted to give the best performance to a specific implementation.

As explained previously herein, using the tiered memory regions in a ratio to the DRAM tiering block size provides near-DRAM performance. The tiered memory devices can be an expansion of memory to increase the size of the memory footprint of the computer system. The tiered memory devices can also be used as a level three (L3) cache. For instance, the host processor 106 in FIG. 1 can include a level one (L1) cache memory, the DRAM 108 can function as level two (L2) cache, and the tiered memory can function as L3 cache. In the event of a L1 miss, the host processor 106 searches the DRAM L2 cache for the data, and in the event of an L2 miss, the host processor 106 searches the tiered memory L3 cache for the data.

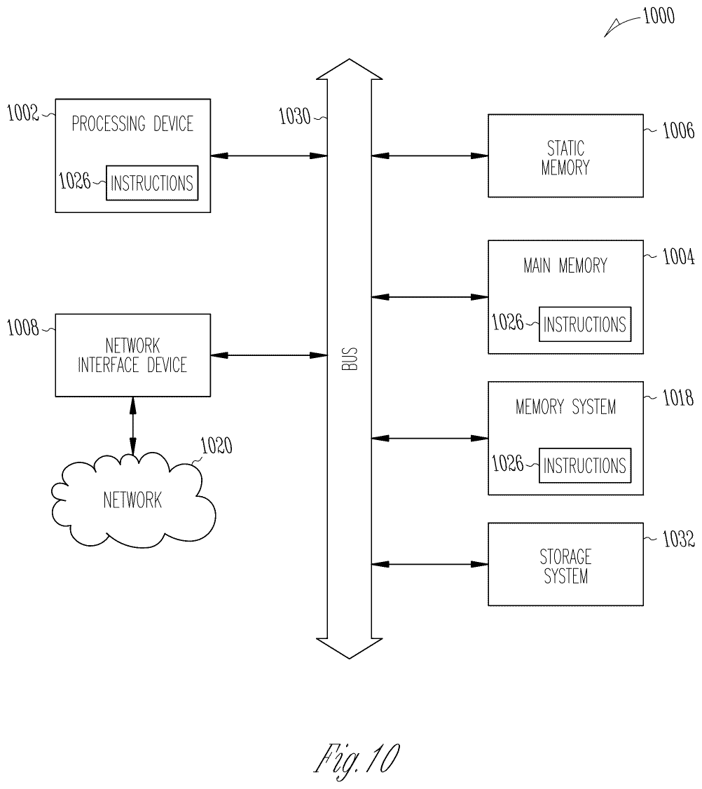

FIG. 10 illustrates a block diagram of an example machine (e.g., a host system) 1000 upon which any one or more of the techniques (e.g., methodologies) discussed herein may perform. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine (e.g., computer system, a host system, etc.) 1000 may include a processing device 1002 (e.g., a hardware processor, a central processing unit (CPU), a graphics processing unit (GPU), a hardware processor core, or any combination thereof, etc.), a main memory 1004 (e.g., read-only memory (ROM), dynamic random-access memory (DRAM) such as synchronous DRAM (SDRAM) or Rambus DRAM (RDRAM), etc.), a static memory 1006 (e.g., static random-access memory (SRAM), etc.), a memory system 1018, and a Storage system 1032, some or all of which may communicate with each other via a communication interface (e.g., a bus) 1030.

The processing device 1002 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 1002 can also be one or more special-purpose processing devices such as an application specific integrated circuit (ASIC), a field programmable gate array (FPGA), a digital signal processor (DSP), network processor, or the like. The processing device 1002 can be configured to execute instructions 1026 for performing the operations and steps discussed herein. The computer system 1000 can further include a network interface device 1008 to communicate over a network 1020.

The memory system 1018 can include a machine-readable storage medium (also known as a computer-readable medium) on which is stored one or more sets of instructions 1026 or software embodying any one or more of the methodologies or functions described herein. The instructions 1026 can also reside, completely or at least partially, within the main memory 1004 or within the processing device 1002 during execution thereof by the computer system 1000, the main memory 1004 and the processing device 1002 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 1000 may further include a display unit, an alphanumeric input device (e.g., a keyboard), and a user interface (UI) navigation device (e.g., a mouse). In an example, one or more of the display units, the input device, or the UI navigation device may be a touch screen display. The machine a signal generation device (e.g., a speaker), or one or more sensors, such as a global positioning system (GPS) sensor, compass, accelerometer, or one or more other sensors. The machine 1000 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 1026 (e.g., software, programs, an operating system (OS), etc.) or other data stored on the storage system 1032 can be accessed by the main memory 1004 for use by the processing device 1002. The main memory 1004 (e.g., DRAM) is typically fast, but volatile, and thus a different type of storage than the storage system 1032 (e.g., an SSD), which is suitable for long-term storage, including while in an “off” condition. The instructions 1026 or data in use by a user or the machine 1000 are typically loaded in the main memory 1004 for use by the processing device 1002. When the main memory 1004 is full, virtual space from the memory system 1018 can be allocated to supplement the main memory 1004; however, because the memory system 1018 device is typically slower than the main memory 1004, and write speeds are typically at least twice as slow as read speeds, use of virtual memory can greatly reduce user experience due to storage system latency (in contrast to the main memory 1004, e.g., DRAM). Further, use of the storage system 1032 for virtual memory can greatly reduce the usable lifespan of the storage system 1032.

The instructions 1026 may further be transmitted or received over a network 1020 using a transmission medium via the network interface device 1008 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1008 may include one or more physical jacks (e.g., Ethernet, coaxial, or phone jacks) or one or more antennas to connect to the network 1020. In an example, the network interface device 1008 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” (in the absence of an express indication to the contrary); the terms “over” and “under” are expressly intended to identify a relative placement of structures (or layers, features, etc.), which expressly includes--but is not limited to--direct contact between the identified structures unless specifically identified as such. Similarly, the terms “over” and “under” are not limited to horizontal orientations, as a structure may be “over” a referenced structure if it is, at some point in time, an outermost portion of the construction under discussion, even if such structure extends vertically relative to the referenced structure, rather than in a horizontal orientation.

The terms “wafer” and “substrate” are used herein to refer generally to any structure on which integrated circuits are formed, and also to such structures during various stages of integrated circuit fabrication. The following detailed description is, therefore, not to be taken in a limiting sense, and the scope of the various embodiments is defined only by the appended claims, along with the full scope of equivalents to which such claims are entitled.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

As used herein, directional adjectives, such as horizontal, vertical, normal, parallel, perpendicular, etc., can refer to relative orientations, and are not intended to require strict adherence to specific geometric properties, unless otherwise noted. For example, as used herein, a vertical structure need not be strictly perpendicular to a surface of a substrate but may instead be generally perpendicular to the surface of the substrate, and may form an acute angle with the surface of the substrate (e.g., between 60 and 120 degrees, etc.).

In some embodiments described herein, different doping configurations may be applied to a select gate source (SGS), a control gate (CG), and a select gate drain (SGD), each of which, in this example, may be formed of or at least include polysilicon, with the result such that these tiers (e.g., polysilicon, etc.) may have different etch rates when exposed to an etching solution. For example, in a process of forming a monolithic pillar in a 3D semiconductor device, the SGS and the CG may form recesses, while the SGD may remain less recessed or even not recessed. These doping configurations may thus enable selective etching into the distinct tiers (e.g., SGS, CG, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (i.e., the memory cell may be programmed to an erased state).

According to one or more embodiments of the present disclosure, a memory controller (e.g., a processor, controller, firmware, etc.) located internal or external to a memory device, is capable of determining (e.g., selecting, setting, adjusting, computing, changing, clearing, communicating, adapting, deriving, defining, utilizing, modifying, applying, etc.) a quantity of wear cycles, or a wear state (e.g., recording wear cycles, counting operations of the memory device as they occur, tracking the operations of the memory device it initiates, evaluating the memory device characteristics corresponding to a wear state, etc.)

According to one or more embodiments of the present disclosure, a memory access device may be configured to provide wear cycle information to the memory device with each memory operation. The memory device control circuitry (e.g., control logic) may be programmed to compensate for memory device performance changes corresponding to the wear cycle information. The memory device may receive the wear cycle information and determine one or more operating parameters (e.g., a value, characteristic) in response to the wear cycle information.

It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Example 1 includes subject matter (such as a computer system) comprising a memory and a processor operatively coupled to the memory. The memory includes dynamic random access memory (DRAM) including a memory tiering portion having a fixed memory tiering block size, and multiple regions of tiered memory, each tiered memory region having the fixed memory tiering block size. The processor is configured to send a memory operation indicating a DRAM cache line stored in the DRAM, receive DRAM metadata stored in the DRAM for the DRAM cache line, identify a tiered memory region of the multiple tiered memory regions storing a tiered memory cache line containing target data of the memory operation when the DRAM metadata indicates that the target data is not stored in the DRAM cache line, and load the tiered memory cache line containing the target data into the DRAM and load the DRAM cache line into the identified tiered memory region and update the DRAM metadata.

In Example 2, the subject matter of Example 1 optionally includes each tiered memory region storing a tiered memory cache line corresponding to the DRAM cache line, and each tiered memory cache line belonging to a different portion of a virtual address space of the memory. The DRAM metadata for the DRAM cache line optionally identifies to which portion of the virtual address space the DRAM cache line belongs and identifies to which portion of the virtual address space the corresponding tiered memory cache lines belong. The processor is optionally configured to identify the tiered memory cache line storing the target data using the DRAM metadata for the DRAM cache line.

In example 3, the subject matter of one or both of Examples 1 and 2 optionally includes the DRAM metadata for the DRAM cache line identifying to which portion of a virtual address space of the memory the cache line in the DRAM belongs, and the processor optionally configured to search tiered memory metadata stored in the tiered memory regions to identify which tiered memory region of the multiple tiered memory regions includes a tiered memory cache line containing the target data when the DRAM metadata indicates that the target data is not stored in the DRAM cache line.

In Example 4, the subject matter of one or any combination of Examples 1-3 optionally includes each tiered memory region storing a tiered memory cache line corresponding to the cache line in DRAM, and the DRAM metadata for the DRAM cache line identifying to which portion of a virtual address space of the memory the DRAM cache line belongs and identifying, for a subset of the multiple tiered memory regions, to which portion of the virtual address space the corresponding tiered memory cache line of a tiered memory region in the subset belongs. The processor is optionally configured to identify the tiered memory region that stores the tiered memory cache line containing the target data using the DRAM metadata when the DRAM metadata indicates that the target data is in a tiered memory cache line of the subset of tiered memory regions, and search tiered memory metadata stored in tiered memory regions not included in the subset of the tiered memory regions to identify the tiered memory cache line that includes the target data when the DRAM metadata indicates that the target data is not in the DRAM cache line and not in a tiered memory cache line of the subset of tiered memory regions.

In Example 5, the subject matter of Example 4 optionally includes the processor configured to update the DRAM metadata for the DRAM cache line by removing DRAM metadata for a least recently used (LRU) tiered memory cache line of a tiered memory region of the subset of tiered memory regions when loading a new tiered memory cache line into the DRAM.

In Example 6, the subject matter of one or any combination of Examples 1-5 optionally includes the DRAM metadata for the DRAM cache line identifying to which portion of a virtual address space of the memory the DRAM cache line belongs, and each tiered memory region storing a tiered memory cache line corresponding to the DRAM cache line, and each tiered memory cache line including tiered memory metadata identifying to which portion of the virtual address space of the memory the tiered memory cache line belongs. The processor is optionally configured to identify an owning tiered memory region of the DRAM cache line using the DRAM metadata when the DRAM metadata indicates that the target data is not in the DRAM cache line, and the contents of the DRAM cache line and the tiered memory cache line of the owning tiered memory region before the loading the tiered memory cache line containing the target data into the DRAM and the loading the DRAM cache line into the identified tiered memory region.

In Example 7, the subject matter of Example 6 optionally includes the memory tiering portion of the DRAM being a level two (L2) cache for the computing system, and the multiple tiered memory regions being a level three (L3) cache for the computing system.

Example 8 includes subject matter (such as a method of operating a computer system) or can optionally be combined with one or any combination of Examples 1-7 to include such subject matter, comprising sending, by an application executing on a processor of the computing system to a dynamic random access memory (DRAM), a memory operation indicating a DRAM cache line stored in the DRAM; receiving, by the processor, DRAM metadata stored in the DRAM for the DRAM cache line; identifying, by the processor, a tiered memory region of multiple tiered memory regions storing a tiered memory cache line containing target data of the memory operation when the DRAM metadata indicates that the target data is not stored in the DRAM cache line; and loading the tiered memory cache line containing the target data into the DRAM, loading the DRAM cache line into the identified tiered memory region, and updating the DRAM metadata.

In Example 9, the subject matter of Example 8 optionally includes storing a tiered memory cache line corresponding to the DRAM cache line in each tiered memory region, wherein each corresponding tiered memory cache line belongs to a different portion of a virtual address space of the memory; identifying, using the DRAM metadata, to which portion of the virtual address space the DRAM cache line belongs and to which portion of the virtual address space the corresponding tiered memory cache lines belong; and identifying the cache line containing the target data according to which portion of the virtual address space the target data belongs.

In Example 10, the subject matter of one or both of Examples 8 and 9 optionally includes identifying, using the DRAM metadata, to which portion of a virtual address space of the memory the DRAM cache line belongs; and searching, by the processor, metadata stored in the tiered memory regions to identify which tiered memory region of the multiple tiered memory regions includes a tiered memory cache line containing the target data when the DRAM metadata indicates that the target data is not stored in the DRAM cache line.

In Example 11, the subject matter of one or any combination of Examples 8-10 optionally includes storing a tiered memory cache line corresponding to the DRAM cache line in each tiered memory region, wherein each corresponding tiered memory cache line belongs to a different portion of a virtual address space of the memory; identifying, using the DRAM metadata, to which portion of the virtual address space the DRAM cache line belongs and, for a subset of the multiple tiered memory regions, to which portion of the virtual address space the corresponding tiered memory cache lines of a tiered memory region in the subset belongs; identifying the tiered memory region that stores the tiered memory cache line containing the target data using the DRAM metadata when the DRAM metadata indicates that the target data is not in the DRAM cache line and is in a tiered memory cache line of the subset of tiered memory regions; and searching, by the processor, tiered memory metadata stored in tiered memory regions not included in the subset of the tiered memory regions to identify the tiered memory cache line that includes the target data when the DRAM metadata indicates that the target data is not in the DRAM cache line and not in a tiered memory cache line of the subset of tiered memory regions.

In Example 12, the subject matter of Example 11 optionally includes updating the DRAM metadata for the DRAM cache line by removing DRAM metadata for a least recently used (LRU) tiered memory cache line of a tiered memory region of the subset of tiered memory regions when loading a new tiered memory cache line into the DRAM.

In Example 13, the subject matter of one or any combination of Examples 8-12 optionally includes sending a memory operation designating a cache line size larger than sixty-four bytes (64B).

In Example 14, the subject matter of one or any combination of Examples 8-13 optionally includes sending a memory operation including an address of a cache line stored in a memory tier portion of the DRAM or in a tiered memory region of multiple tiered memory regions that are each a size of the memory tier portion of the DRAM.

In Example 15, the subject matter of one or any combination of Examples 8-14 optionally includes sending the memory operation to a level two (L2) cache in the DRAM; and identifying the tiered memory region of multiple tiered memory regions of a level three (L3) cache that includes the target data.

Example 16 includes subject matter (such as a host device) or can optionally be combined with one or any combination of Examples 1-15 to include such subject matter, comprising a host processor configured to send a memory operation from an application executing on the host processor to a dynamic random access memory (DRAM) of a memory system, wherein the memory operation includes an address of a DRAM cache line stored in the DRAM; decode DRAM metadata stored in the DRAM for the DRAM cache line; identify a tiered memory region, of multiple tiered memory regions of the memory system, storing a tiered memory cache line containing target data of the memory operation when the DRAM metadata indicates that the target data is not stored in the DRAM cache line; and swap data of the tiered memory cache line of identified tiered memory region and the DRAM cache line in response to receiving the metadata.

In Example 17, the subject matter of Example 16 optionally includes the host processor configured to identify a portion of a virtual address space of the memory system that includes the target data; and decode, in the DRAM metadata, a tiered memory cache line corresponding to the DRAM cache line for the identified portion of the virtual memory address space and the tiered memory region storing the identified tiered memory cache line.

In Example 18, the subject matter of one or both of Examples 16 and 17 optionally includes the host processor configured to identify a portion of a virtual address space of the memory that contains the target data; and search tiered memory metadata stored in the tiered memory regions to identify which tiered memory cache line of the multiple tiered memory regions contains the target data when the target data is not in the DRAM cache line.

In Example 19, the subject matter of one or any combination of Examples 16-18 optionally includes the host processor configured to identify a portion of a virtual address space of the memory that contains the target data; decode, in the DRAM metadata, to which portion of the virtual address space the DRAM cache line belongs and, for a subset of the multiple tiered memory regions, to which portion of the virtual address space tiered memory cache lines in the subset of tiered memory regions corresponding to the DRAM cache line belongs; and search metadata stored in the tiered memory regions not included in the subset of tiered memory regions to identify which tiered memory cache line belongs to the identified portion of the virtual address space when the DRAM cache line and tiered memory cache lines of the subset of the tiered memory regions do not belong to the identified portion of the virtual address space.

In Example 20, the subject matter of Example 19 optionally includes the host processor configured to update the DRAM metadata for the DRAM cache line by removing DRAM metadata for a least recently used (LRU) tiered memory cache line of a tiered memory region of the subset of tiered memory regions when loading a new tiered memory cache line into the DRAM.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A computer system comprising:
a memory including:
dynamic random access memory (DRAM) including a memory tiering portion having a fixed memory tiering block size; and
multiple regions of tiered memory, each tiered memory region having the fixed memory tiering block size; and
a processor operatively coupled to the memory and configured to:
send a memory operation indicating a DRAM cache line stored in the DRAM;
receive DRAM metadata stored in the DRAM for the DRAM cache line;
identify a tiered memory region of the multiple tiered memory regions storing a tiered memory cache line containing target data of the memory operation when the DRAM metadata indicates that the target data is not stored in the DRAM cache line; and
load the tiered memory cache line containing the target data into the DRAM and load the DRAM cache line into the identified tiered memory region and update the DRAM metadata.

2. The computer system of claim 1,
wherein each tiered memory region stores a tiered memory cache line corresponding to the DRAM cache line, and each tiered memory cache line belongs to a different portion of a virtual address space of the memory;
wherein the DRAM metadata for the DRAM cache line identifies to which portion of the virtual address space the DRAM cache line belongs and identifies to which portion of the virtual address space the corresponding tiered memory cache lines belong; and
wherein the processor is configured to identify the tiered memory cache line storing the target data using the DRAM metadata for the DRAM cache line.

3. The computer system of claim 1,
wherein the DRAM metadata for the DRAM cache line identifies to which portion of a virtual address space of the memory the cache line in the DRAM belongs; and
wherein the processor is configured to search tiered memory metadata stored in the tiered memory regions to identify which tiered memory region of the multiple tiered memory regions includes a tiered memory cache line containing the target data when the DRAM metadata indicates that the target data is not stored in the DRAM cache line.

4. The computer system of claim 1,
wherein each tiered memory region stores a tiered memory cache line corresponding to the cache line in DRAM;
wherein the DRAM metadata for the DRAM cache line identifies to which portion of a virtual address space of the memory the DRAM cache line belongs and identifies, for a subset of the multiple tiered memory regions, to which portion of the virtual address space the corresponding tiered memory cache line of a tiered memory region in the subset belongs; and
wherein the processor is configured to:
identify the tiered memory region that stores the tiered memory cache line containing the target data using the DRAM metadata when the DRAM metadata indicates that the target data is in a tiered memory cache line of the subset of tiered memory regions; and
search tiered memory metadata stored in tiered memory regions not included in the subset of the tiered memory regions to identify the tiered memory cache line that includes the target data when the DRAM metadata indicates that the target data is not in the DRAM cache line and not in a tiered memory cache line of the subset of tiered memory regions.

5. The computer system of claim 4
wherein the processor is configured to update the DRAM metadata for the DRAM cache line by removing DRAM metadata for a least recently used (LRU) tiered memory cache line of a tiered memory region of the subset of tiered memory regions when loading a new tiered memory cache line into the DRAM.

6. The computer system of claim 1,
wherein the DRAM metadata for the DRAM cache line identifies to which portion of a virtual address space of the memory the DRAM cache line belongs;
wherein each tiered memory region stores a tiered memory cache line corresponding to the DRAM cache line, and each tiered memory cache line includes tiered memory metadata identifying to which portion of the virtual address space of the memory the tiered memory cache line belongs;
wherein the processor is configured to:
identify an owning tiered memory region of the DRAM cache line using the DRAM metadata when the DRAM metadata indicates that the target data is not in the DRAM cache line; and
swap the contents of the DRAM cache line and the tiered memory cache line of the owning tiered memory region before the loading the tiered memory cache line containing the target data into the DRAM and the loading the DRAM cache line into the identified tiered memory region.

7. The computer system of claim 1,
wherein the memory tiering portion of the DRAM is a level two (L2) cache for the computing system; and
wherein the multiple tiered memory regions are a level three (L3) cache for the computing system.

8. A method of operating a computing system, the method comprising:
sending, by an application executing on a processor of the computing system to a dynamic random access memory (DRAM), a memory operation indicating a DRAM cache line stored in the DRAM;
receiving, by the processor, DRAM metadata stored in the DRAM for the DRAM cache line;
identifying, by the processor, a tiered memory region of multiple tiered memory regions storing a tiered memory cache line containing target data of the memory operation when the DRAM metadata indicates that the target data is not stored in the DRAM cache line; and
loading the tiered memory cache line containing the target data into the DRAM, loading the DRAM cache line into the identified tiered memory region, and updating the DRAM metadata.

9. The method of claim 8, including:
storing a tiered memory cache line corresponding to the DRAM cache line in each tiered memory region, wherein each corresponding tiered memory cache line belongs to a different portion of a virtual address space of the memory; and
wherein the identifying the tiered memory region storing the tiered memory cache line containing the target data includes:
identifying, using the DRAM metadata, to which portion of the virtual address space the DRAM cache line belongs and to which portion of the virtual address space the corresponding tiered memory cache lines belong; and
identifying the cache line containing the target data according to which portion of the virtual address space the target data belongs.

10. The method of claim 8, wherein the identifying the tiered memory region that contains the target data includes:
identifying, using the DRAM metadata, to which portion of a virtual address space of the memory the DRAM cache line belongs; and
searching, by the processor, metadata stored in the tiered memory regions to identify which tiered memory region of the multiple tiered memory regions includes a tiered memory cache line containing the target data when the DRAM metadata indicates that the target data is not stored in the DRAM cache line.

11. The method of claim 8, including:
storing a tiered memory cache line corresponding to the DRAM cache line in each tiered memory region, wherein each corresponding tiered memory cache line belongs to a different portion of a virtual address space of the memory; and
wherein the identifying the tiered memory region that contains the target data includes:
identifying, using the DRAM metadata, to which portion of the virtual address space the DRAM cache line belongs and, for a subset of the multiple tiered memory regions, to which portion of the virtual address space the corresponding tiered memory cache lines of a tiered memory region in the subset belongs;
identifying the tiered memory region that stores the tiered memory cache line containing the target data using the DRAM metadata when the DRAM metadata indicates that the target data is not in the DRAM cache line and is in a tiered memory cache line of the subset of tiered memory regions; and
searching, by the processor, tiered memory metadata stored in tiered memory regions not included in the subset of the tiered memory regions to identify the tiered memory cache line that includes the target data when the DRAM metadata indicates that the target data is not in the DRAM cache line and not in a tiered memory cache line of the subset of tiered memory regions.

12. The method of claim 11, including updating the DRAM metadata for the DRAM cache line by removing DRAM metadata for a least recently used (LRU) tiered memory cache line of a tiered memory region of the subset of tiered memory regions when loading a new tiered memory cache line into the DRAM.

13. The method of claim 8, wherein the sending the memory operation to the DRAM includes sending a memory operation designating a cache line size larger than sixty-four bytes (64 B).

14. The method of claim 8, wherein the sending the memory operation from the processor includes sending a memory operation including an address of a cache line stored in a memory tier portion of the DRAM or in a tiered memory region of multiple tiered memory regions that are each a size of the memory tier portion of the DRAM.

15. The method of claim 8,
wherein the sending the memory operation to the DRAM includes sending the memory operation to a level two (L2) cache in the DRAM; and
wherein the identifying the tiered memory region including the target data includes identifying the tiered memory region of multiple tiered memory regions of a level three (L3) cache that includes the target data.

16. A host device comprising:
a host processor configured to:
send a memory operation from an application executing on the host processor to a dynamic random access memory (DRAM) of a memory system, wherein the memory operation includes an address of a DRAM cache line stored in the DRAM;
decode DRAM metadata stored in the DRAM for the DRAM cache line;
identify a tiered memory region, of multiple tiered memory regions of the memory system, storing a tiered memory cache line containing target data of the memory operation when the DRAM metadata indicates that the target data is not stored in the DRAM cache line; and
swap data of the tiered memory cache line of identified tiered memory region and the DRAM cache line in response to receiving the metadata.

17. The host device of claim 16, wherein the host processor is configured to:
identify a portion of a virtual address space of the memory system that includes the target data; and
decode, in the DRAM metadata, a tiered memory cache line corresponding to the DRAM cache line for the identified portion of the virtual memory address space and the tiered memory region storing the identified tiered memory cache line.

18. The host device of claim 16, wherein the host processor is configured to:
identify a portion of a virtual address space of the memory that contains the target data; and
search tiered memory metadata stored in the tiered memory regions to identify which tiered memory cache line of the multiple tiered memory regions contains the target data when the target data is not in the DRAM cache line.

19. The host device of claim 16, wherein the host processor is configured to:
identify a portion of a virtual address space of the memory that contains the target data;
decode, in the DRAM metadata, to which portion of the virtual address space the DRAM cache line belongs and, for a subset of the multiple tiered memory regions, to which portion of the virtual address space tiered memory cache lines in the subset of tiered memory regions corresponding to the DRAM cache line belongs; and
search metadata stored in the tiered memory regions not included in the subset of tiered memory regions to identify which tiered memory cache line belongs to the identified portion of the virtual address space when the DRAM cache line and tiered memory cache lines of the subset of the tiered memory regions do not belong to the identified portion of the virtual address space.

20. The host device of claim 19, wherein the host processor is configured to:
update the DRAM metadata for the DRAM cache line by removing DRAM metadata for a least recently used (LRU) tiered memory cache line of a tiered memory region of the subset of tiered memory regions when loading a new tiered memory cache line into the DRAM.
